(19) United States
(12) Patent Application Publication
(10) Pub. No.: US 2014/0364561 A1
(43) Pub. Date: Dec. 11, 2014

(54) ETHYLENE-BASED POLYMERS PREPARED BY DISPERSION POLYMERIZATION

(71) Applicant: DOW GLOBAL TECHNOLOGIES LLC, Midland, MI (US)

(72) Inventors: Kishori Deshpande, Lake Jackson, TX (US); Ravindre S. Dixit, Lake Jackson, TX (US); Pradeep Jain, Lake Jackson, TX (US)

(73) Assignee: Dow Global Technologies LLC, Midland, MI (US)

(21) Appl. No.: 14/366,880

(22) PCT Filed: Dec. 19, 2012
(86) PCT No.: PCT/US2012/070559

§ 371 Date: Jun. 19, 2014

Related U.S. Application Data
(60) Provisional application No. 61/577,232, filed on Dec. 19, 2011.

(51) Int. Cl. C08F 210/16

(52) U.S. Cl. CPC C08F 210/16
USPC 524/579; 526/348.2

(57) ABSTRACT

The invention provides a composition comprising an ethylene-based polymer comprising at least the following properties: a) a weight average molecular weight (Mw(abs)) greater than, or equal to, 60,000 g/mole; and b) a molecular weight distribution (Mw(abs)/Mn(abs)) greater than, or equal to, 2.3.

### REFERENCE TO RELATED APPLICATIONS

The present application claims the benefit of U.S. Provisional Application No. 61/577,232, filed Dec. 19, 2011, and International Application No. PCT/US11/066417, filed Dec. 21, 2011.

### BACKGROUND OF THE INVENTION

There is a need for higher molecular weight ethylene-based polymers that have improved processing and improved toughness. Such polymers are needed in sealing applications which require tough, high molecular weight polymers. These polymers typically cannot be prepared using conventional solution polymerization processes, because the polymer viscosity limits the ability to process the polymer.

U.S. Pat. No. 5,278,272 discloses elastic, substantially linear olefin polymers which have very good processability, including processing indices (PI's) less than, or equal to, 70 percent of those of a comparative linear olefin polymer, and a critical shear rate, at onset of surface melt fracture, of at least 50 percent greater, than the critical shear rate, at the onset of surface melt fracture, of a traditional linear olefin polymer, at about the same melt index (I2) and molecular weight distribution. The polymers have higher “low/zero shear viscosity” and lower “high shear viscosity” than comparative linear olefin polymers.

U.S. Pat. No. 6,680,361 discloses shear-thinning ethylene/α-olefin and ethylene/α-olefin/diene interpolymers that do not include a traditional branch-inducing monomer, such as norbornadiene. Such polymers are prepared at an elevated temperature, in an atmosphere that has little, or no, hydrogen, using a constrained geometry complex catalyst and an activating cocatalyst.

International Publication WO 2011/002998 discloses ethylenic polymers comprising low levels of total unsaturation. Compositions using such ethylene polymers, and fabricated articles made from them, are also disclosed.

International Publication WO 2011/002986 discloses ethylene polymers having low levels of long chain branching. Films and film layers made from these polymers have good hot tack strength over a wide range of temperatures, making them good materials for packaging applications.

International Publication WO 2007/136497 discloses a catalyst composition comprising one or more metal complexes of a multifunctional Lewis base ligand, comprising a bulky, planar, aromatic- or substituted aromatic-group. Polymerization processes employing the same, and especially continuous, solution polymerization of one or more α-olefins, at high catalyst efficiencies, are also disclosed.

International Publication WO 2007/136496 discloses metal complexes of polyvalent aryloxyethers, appropriately substituted with sterically bulky substituents. These metal complexes possess enhanced solubility in aliphatic and cycloaliphatic hydrocarbons, and/or when employed as catalyst components for the polymerization of ethylene/α-olefin copolymers, produce products having reduced I₁₀/I₂ values.

International Publication WO 2007/136494 discloses a catalyst composition comprising a zirconium complex of a polyvalent aryloxyether, and the use thereof, in a continuous solution polymerization of ethylene, one or more C₃₋₃₀ olefins, and a conjugated or nonconjugated diene, to prepare interpolymers having improved processing properties.

Additional ethylene-based polymers and/or processes are described in the following: U.S. Pat. Nos. 6,255,410, 4,433,121, U.S. Pat. No. 3,932,371, U.S. Pat. No. 4,444,922; International Publication Nos. WO 02/34795, WO 04/026923, WO 08/079565, WO 11/008837; R. E. van Vliet et al, The Use of Liquid-Liquid Extraction in the EPDM Solution Polymerization Process, Ind. Eng. Chem. Res., 2001, 40(21), 4586-4595.

However, the ethylene-based polymers of the art typically have lower molecular weights due to lower viscosities needed to run the polymerizations, and typically contain lower comonomer incorporation, which decreases the toughness of the polymer. As discussed, there remains a need for higher molecular weight ethylene-based polymers that have improved processibility and improved toughness. These needs have been met by the following invention.

### SUMMARY OF INVENTION

The invention provides a composition comprising an ethylene-based polymer comprising at least the following properties:
a) a weight average molecular weight (Mw(abs)) greater than, or equal to, 60,000 g/mole; and
b) a molecular weight distribution (Mw(abs)/Mn(abs)) greater than, or equal to, 2.3.

### BRIEF DESCRIPTION OF THE DRAWINGS

FIG. 1 is a flow schematic of an inventive polymerization process.

FIG. 2 depicts a run profile (T, P versus time) for an inventive polymerization process.

FIG. 3 is a plot of “weight percent octene incorporation versus density” of several inventive and comparative polymers.

FIG. 4 is a plot of “molecular weight distribution versus density” of several inventive and comparative polymers.

### DETAILED DESCRIPTION

As discussed above, the invention provides a composition comprising an ethylene-based polymer comprising at least the following properties:
a) a weight average molecular weight (Mw(abs)) greater than, or equal to, 60,000 g/mole; and
b) a molecular weight distribution (Mw(abs)/Mn(abs)) greater than, or equal to, 2.3.

An inventive composition may comprise a combination of two or more embodiments as described herein.

An inventive ethylene-based polymer may comprise a combination of two or more embodiments as described herein.

In one embodiment, the ethylene-based polymer further comprises a density from 0.85 to 0.91 g/cc, or from 0.85 to 0.90 g/cc (1 cc=1 cm³).

In one embodiment, the ethylene-based polymer is an ethylene/α-olefin interpolymer.

In one embodiment, the ethylene-based polymer is an ethylene/α-olefin copolymer.

In one embodiment, the α-olefin is selected from C3-C10 α-olefin(s). Illustrative α-olefins include propylene, 1-butene, 1-pentene, 1-hexene, 4-methyl-1-pentene, 1-heptene, 1-octene, 1-nonene and 1-decene. Preferably, the α-olefin is propylene, 1-butene, 1-hexene or 1-octene, more preferably 1-butene, 1-hexene or 1-octene.

In one embodiment, the ethylene-based polymer has an α-olefin incorporation greater than, or equal to, 30 weight percent, based on the weight of the polymer.

In one embodiment, the ethylene-based polymer has an α-olefin incorporation greater than, or equal to, 32 weight percent, based on the weight of the polymer.

In one embodiment, the ethylene-based polymer has an α-olefin incorporation greater than, or equal to, 34 weight percent, based on the weight of the polymer.

In one embodiment, the ethylene-based polymer has a molecular weight distribution (Mw(abs)/Mn(abs)) from 2.3 to 5.0.

In one embodiment, the ethylene-based polymer has a molecular weight distribution (Mw(abs)/Mn(abs)) from 2.4 to 4.6.

In one embodiment, the ethylene-based polymer has a molecular weight distribution (Mw(abs)/Mn(abs)) from 2.5 to 4.4.

In one embodiment, the ethylene-based polymer has a density greater than 0.855 g/cc, and an α-olefin incorporation greater than, or equal to, 30 weight percent, based on the weight of the polymer.

In one embodiment, the ethylene-based polymer has a density greater than 0.855 g/cc, and an α-olefin incorporation greater than, or equal to, 31 or greater than, or equal to, 32, weight percent, based on the weight of the polymer.

In one embodiment, the ethylene-based polymer has a density greater than 0.860 g/cc, or greater than 0.865 g/cc, and an α-olefin incorporation greater than, or equal to, 31 or greater than, or equal to, 32, weight percent, based on the weight of the polymer.

In one embodiment, the ethylene-based polymer has a density greater than 0.855 g/cc, and a molecular weight distribution (Mw(abs)/Mn(abs)) greater than, or equal to, 2.4.

In one embodiment, the ethylene-based polymer has a density greater than 0.860 g/cc, or greater than 0.865 g/cc, and a molecular weight distribution (Mw(abs)/Mn(abs)) greater than, or equal to, 2.45 or greater than, or equal to, 2.55, or greater than, or equal to, 3.0, or greater than, or equal to, 4.0, or greater than, or equal to, 5.0.

In one embodiment, the ethylene-based polymer alpha (α) parameter less 0.72.

In one embodiment, the ethylene-based polymer has a weight average molecular weight (Mw(abs)) greater than, or equal to, 70,000 g/mole, or greater than, or equal to, 75,000 g/mole, or greater than, or equal to, 80,000 g/mole.

In one embodiment, the ethylene-based polymer has a weight average molecular weight (Mw(abs)) greater than, or equal to, 90,000 g/mole, or greater than, or equal to, 100,000 g/mole.

In one embodiment, the ethylene-based polymer has a weight average molecular weight (Mw(abs)) from 60,000 to 500,000 g/mole, or from 70,000 to 450,000 g/mole, and a MWD greater than, or equal to, 2.3, or greater than, or equal to, 2.4.

In one embodiment, the ethylene-based polymer has a weight average molecular weight (Mw(abs)) from 60,000 to 500,000 g/mole, or from 70,000 to 450,000 g/mole, and an α-olefin incorporation greater than, or equal to, 30 or greater than, or equal to, 32 weight percent, based on the weight of the polymer.

In one embodiment, the ethylene-based polymer has an I10/I2 ratio greater than, or equal to, 8.0, or greater than, or equal to, 8.5.

In one embodiment, the ethylene-based polymer has an I10/I2 ratio greater than, or equal to, 10.0, or greater than, or equal to, 10.5.

In one embodiment, the ethylene-based polymer is an ethylene/α-olefin/diene terpolymer, and further an EPDM. In a further embodiment, the diene is ENB.

An inventive ethylene-based polymer may comprise a combination of two or more embodiments as described herein.

In one embodiment, the composition further comprises at least one additive. In a further embodiment, the additive is selected from antioxidants, fillers, plasticizers, or combinations thereof.

An inventive composition may comprise a combination of two or more embodiments as described herein.

The invention also provides an article comprising at least one component formed from an inventive composition.

In one embodiment, the article is selected from a gasket or a profile.

An inventive article may comprise a combination of two or more embodiments as described herein.

Applicants have discovered that the inventive polymers have a unique combination of high molecular weight, relatively broad molecular weight distribution, high comonomer incorporation, and sufficient long chain branching. The inventive polymers have good processabilty and can be used in applications that require good tensile strength and good toughness.

The invention also provides a process to prepare an olefin-based polymer, said process comprising polymerizing the olefin, and optionally at least one comonomer, using a dispersion polymerization.

In one embodiment, the olefin-based polymer is an ethylene-based polymer as described herein.

In one embodiment, the olefin-based polymer is a propylene-based polymer. In a further embodiment, the propylene-based polymer is a propylene/ethylene interpolymer, and further a propylene/ethylene copolymer. In another embodiment, the propylene-based polymer is a propylene/α-olefin interpolymer, and further a propylene/α-olefin copolymer.

In one embodiment, the dispersion polymerization comprises a two-liquid phase region above a critical temperature and pressure, inducing poor solubility for the olefin-based polymer in an appropriate solvent. Further, the polymer-rich, high viscosity phase is dispersed as droplets in a continuous low viscosity solvent phase. The effective viscosity of the dispersed phases is low, thus eliminating the viscosity limitations of current single-phase solution reactors, allowing the synthesis of higher molecular weight olefin-based polymers, and minimizing viscosity constraints.

Further, as the two phases differ in density, the dispersion can be decanted, post-reactor, to deliver a concentrated polymer phase which can be devolatilized with minimal heat addition (temperatures<200° C.). The solvent-rich stream from decanter can be cooled to remove the heat of polymerization, and re-cycled back to the reactor.

### Ethylene-Based Polymers

In one embodiment, the ethylene-based polymer is an ethylene/α-olefin interpolymer. In a further embodiment, an ethylene/α-olefin copolymer. In another embodiment, an ethylene/α-olefin/diene interpolymer

### Ethylene/α-Olefin Interpolymers

Ethylene/α-olefin interpolymers include polymers formed by polymerizing ethylene with one or more, and preferably one, C3-C10 α-olefin(s). Illustrative α-olefins include propylene, 1-butene, 1-pentene, 1-hexene, 4-methyl-1-pentene, 1-heptene, 1-octene, 1-nonene and 1-decene. Preferably, the α-olefin is propylene, 1-butene, 1-hexene or 1-octene, or 1-butene, 1-hexene or 1-octene, or 1-octene.

Preferred copolymers include ethylene/propylene (EP) copolymers, ethylene/butene (EB) copolymers, ethylene/hexene (EH) copolymers, ethylene/octene (EO) copolymers.

An ethylene/α-olefin interpolymer may comprise a combination of two or more embodiments described herein.

An ethylene/α-olefin copolymer may comprise a combination of two or more embodiments described herein.

### Ethylene/α-Olefin/Diene Interpolymers

The ethylene/α-olefin/diene interpolymers have polymerized therein ethylene, at least one α-olefin and a diene. Suitable examples of α-olefins include the C3-C20 α-olefins. Examples of suitable dienes include the C4-C40 non-conjugated dienes.

The α-olefin is preferably a C3-C20 α-olefin, preferably a C3-C16 α-olefin, and more preferably a C3-C10 α-olefin. Preferred C3-C10 α-olefins are selected from the group consisting of propylene, 1-butene, 1-hexene and 1-octene, and more preferably propylene. In a further embodiment, the interpolymer is an EPDM terpolymer. In a further embodiment, the diene is 5-ethylidene-2-norbornene (ENB).

In one embodiment, the diene is a C6-C15 straight chain, branched chain or cyclic hydrocarbon diene. Illustrative non-conjugated dienes are straight chain, acyclic dienes, such as 1,4-hexadiene and 1,5-heptadiene; branched chain, acyclic dienes, such as 5-methyl-1,4-hexadiene, 2-methyl-1,5-hexadiene, 6-methyl-1,5-heptadiene, 7-methyl-1,6-octadiene, 3,7-dimethyl-1,6-octadiene, 3,7-dimethyl-1,7-octadiene, 5,7-dimethyl-1,7-octadiene, 1,9-decadiene, and mixed isomers of dihydromyrcene; single ring alicyclic dienes such as 1,4-cyclohexadiene, 1,5-cyclooctadiene and 1,5-cyclododecadiene; multi-ring alicyclic fused and bridged ring dienes, such as tetrahydroindene, methyl tetrahydroindene; alkenyl, alkylidene, cycloalkenyl and cycloalkylidene norbornenes such as 5-methylene-2-norbornene (MNB), 5-ethylidene-2-norbornene (ENB), 5-vinyl-2-norbornene, 5-propenyl-2-norbornene, 5-isopropylidene-2-norbornene, 5-(4-cyclopentenyl)-2-norbornene, and 5-cyclohexylidene-2-norbornene. The diene is preferably a non-conjugated diene selected from ENB, dicyclopentadiene, 1,4-hexadiene, or 7-methyl-1,6-octadiene, and preferably, ENB, dicyclopentadiene or 1,4-hexadiene, more preferably ENB or dicyclopentadiene, and even more preferably ENB.

In one embodiment, the ethylene/α-olefin/diene interpolymer comprises a majority amount of polymerized ethylene, based on the weight of the interpolymer. In a further embodiment, the interpolymer is an EPDM terpolymer. In a further embodiment, the diene is 5-ethylidene-2-norbornene (ENB).

An ethylene/α-olefin/diene interpolymer may comprise a combination of two or more embodiments described herein.

An EPDM may comprise a combination of two or more embodiments described herein.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term “ethylene-based polymer,” as used herein, refers to a polymer that comprises at least a majority weight percent polymerized ethylene (based on the weight of polymer), and, optionally, one or more additional comonomers.

The term “ethylene/α-olefin interpolymer,” as used herein, refers to an interpolymer that comprises, in polymerized form, a majority amount of ethylene monomer (based on the weight of the interpolymer), and an α-olefin.

The term “ethylene/α-olefin copolymer,” as used herein, refers to a copolymer that comprises, in polymerized form, a majority amount of ethylene monomer (based on the weight of the copolymer), and an α-olefin, as the only two monomer types.

The term “ethylene/α-olefin/diene interpolymer,” as used herein, refers to a polymer that comprises, in polymerized form, ethylene, an α-olefin, and a diene. In one embodiment, the “ethylene/α-olefin/diene interpolymer,” comprises a majority weight percent of ethylene (based on the weight of the interpolymer).

The term “ethylene/α-olefin/diene terpolymer,” as used herein, refers to a polymer that comprises, in polymerized form, ethylene, an α-olefin, and a diene, as the only three monomer types. In one embodiment, the “ethylene/α-olefin/diene terpolymer” comprises a majority weight percent of ethylene (based on the weight of the terpolymer).

The terms “comprising,” “including,” “having,” and their derivatives, are not intended to exclude the presence of any additional component, step or procedure, whether or not the same is specifically disclosed. In contrast, the term “consisting essentially of” excludes from the scope of any succeeding recitation any other component, step or procedure, excepting those that are not essential to operability. The term “consisting of” excludes any component, step or procedure not specifically delineated or listed.

### Test Methods

### Triple Detector GPC (RAD GPC)

A high temperature “Triple Detector Gel Permeation Chromatography (3D-GPC)” system, equipped with Robotic Assistant Delivery (RAD) system for sample preparation and sample injection, was used. The concentration detector is an Infra-red concentration detector (IR4 from Polymer Char, Valencia, Spain), which was used to determine the molecular weight and molecular weight distribution. Other two detectors are a Precision Detectors (Amherst, Mass.) 2-angle laser light scattering detector, Model 2040, and a 4-capillary differential viscometer detector, Model 150R, from Viscotek (Houston, Tex.). The 15° angle of the light scattering detector was used for calculation purposes. The detectors arranged were arranged in series in the following order: light scattering detector, IR-4 detector, and viscometer detector.

Data collection was performed using Polymer Char DM 100 Data acquisition box. The carrier solvent was 1,2,4-trichlorobenzene (TCB). The system was equipped with an on-line solvent degas device (from Agilent Technologies Inc.). The column compartment was operated at 150° C. The columns were four, OLEXIS, 30 cm, 13 micron columns (from Agilent Technologies Inc.). The samples were prepared at “2.0 mg/mL” using the RAD system. The chromatographic solvent (TCB) and the sample preparation solvent contained “200 ppm of butylated hydroxytoluene (BHT),” and both solvent sources were nitrogen sparged (continuous bubbling of nitrogen). The ethylene-based polymer samples were stirred gently at 155° C. for three hours. The injection volume was 200 μl, and the flow rate was 1.0 ml/minute.

Data was collected using TriSEC (excel-based) software. Calibration of the GPC columns was performed with 21 narrow, molecular weight distribution polystyrene standards. The molecular weights of the standards ranged from 580 to 8,400,000 g/mol, and were arranged in six “cocktail” mixtures, with at least a decade of separation between individual molecular weights.

The polystyrene standard peak molecular weights were converted to polyethylene molecular weights using the following equation (as described in T. Williams and I. M. Ward, J. Polym. Sci., Polym. Let., 6, 621 (1968)):

M_{polyethylene}=A(M_{polystyrene})^{B} (1),

where B has a value of 1.0, and the experimentally determined value of A is 0.38.

A first order polynomial was used to fit the respective polyethylene-equivalent calibration points obtained from equation (1) to their observed elution volumes. The actual polynomial fit was obtained, so as to relate the logarithm of polyethylene equivalent molecular weights to the observed elution volumes (and associated powers) for each polystyrene standard.

Conventional number, weight, and z-average molecular weights were calculated according to the following equations:

$$\begin{matrix}\overline{Mn} = \frac{{\sum }^{i} W {f}_{i}}{{\sum }^{i} ( \frac{W {f}_{i}}{{M}_{i}} )} , & ( 2 ) \\ \overline{Mw} = \frac{{\sum }^{i} ( W {f}_{i} * {M}_{i} )}{{\sum }^{i} W {f}_{i}} , & ( 3 ) \\ \overline{Mz} = \frac{{\sum }^{i} ( W {f}_{i} * {M}_{i}^{2} )}{{\sum }^{i} ( W {f}_{i} * {M}_{i} )} , & ( 4 )\end{matrix}$$

where, Wfᵢ is the weight fraction of the i-th component, and Mᵢ is the molecular weight of the i-th component.

The MWD was expressed as the ratio of the weight average molecular weight (Mw) to the number average molecular weight (Mn). The A value was determined by adjusting the “A value” in equation (1) until Mw, the weight average molecular weight calculated using equation (3) and the corresponding retention volume polynomial, agreed with the independently determined value of Mw obtained in accordance with the linear homopolymer reference with known weight average molecular weight of 115,000 g/mol.

The Systematic Approach for the determination of each detector offset was implemented in a manner consistent with that published by Balke, Mourey, et al . (T. H. Mourey and S. T. Balke, in “Chromatography of Polymers (ACS Symposium Series, #521),” T. Provder Eds., An American Chemical Society Publication, 1993, Chpt. 12, p. 180; S. T. Balke, R. Thitiratsakul, R. Lew, P. Cheung, T. H. Mourey, in “Chromatography of Polymers (ACS Symposium Series, #521),” T. Provder Eds., An American Chemical Society Publication, 1993, Chpt 13, p. 199), using data obtained from the three detectors, while analyzing the broad linear polyethylene homopolymer (115,000 g/mol) and the narrow polystyrene standards. The Systematic Approach was used to optimize each detector offset, to give molecular weight results as close as possible to those observed using the conventional GPC method. The overall injected concentration, used for the determinations of the molecular weight and intrinsic viscosity, was obtained from the sample infra-red area, and the infra-red detector calibration (or mass constant) from the linear polyethylene homopolymer of 115,000 g/mol. The chromatographic concentrations were assumed low enough to eliminate addressing 2^{nd} Virial coefficient effects (concentration effects on molecular weight).

The absolute molecular weight was calculated use the 15° laser light scattering signal and the IR concentration detector, M_{PEi, abs}=K_{LS}*(LSᵢ)/(IRᵢ), using the same K_{LS} calibration constant as in Equation 5. The paired data set of the i^{th} slice of the IR response and LS response was adjusted using the determined “off-set” as discussed in the above Systematic Approach.

In addition to the above calculations, a set of alternative Mw, Mn, Mz and M_{Z+1} [Mw (abs), Mz (abs), Mz (BB) and M_{Z+1} (BB)] values were also calculated with the method proposed by Yau and Gillespie, (W. W. Yau and D. Gillespie, Polymer, 42, 8947-8958 (2001)), and determined from the following equations:

$$\overline{Mw} ( abs ) = {K}_{LS} * \frac{{\sum }^{i} ( L {S}_{i} )}{{\sum }^{i} ( I {R}_{i} )} , \qquad ( 5 )$$

where, K_{LS}=LS−MW calibration constant (the response factor, K_{LS}, of the laser detector was determined using the certificated value for the weight average molecular weight of NIST 1475 (52,000 g/mol),

$$\begin{matrix}Mn ( abs ) = {K}_{LS} \frac{\sum ( I {R}_{i} )}{\sum ( I {R}_{i} ) / ( {LS}_{i} / {IR}_{i} )} & ( 6 ) \\ \overline{Mz} ( abs ) = \frac{{\sum }^{i} {IR}_{i} * {( L {S}_{i} / {IR}_{i} )}^{2}}{{\sum }^{i} {IR}_{i} * ( {LS}_{i} / I {R}_{i} )} , & ( 7 ) \\ \overline{Mz} ( BB ) = \frac{{\sum }^{i} ( L {S}_{i} * {M}_{i} )}{{\sum }^{i} ( {LS}_{i} )} , & ( 8 ) \\ \overline{{M}_{Z + 1}} ( BB ) = \frac{{\sum }^{i} ( L {S}_{i} * {M}_{i}^{2} )}{{\sum }^{i} ( {LS}_{i} * {M}_{i} )} , & ( 9 )\end{matrix}$$

where LSᵢ is the 15 degree LS signal, and the Mᵢ uses Equation 2, and the LS detector alignment is as described previously.

In order to monitor the deviations over time, which may contain an elution component (caused by chromatographic changes) and a flow rate component (caused by pump changes), a late eluting narrow peak is generally used as a “flow rate marker peak.” A flow rate marker was therefore established based on a decane flow marker dissolved in the eluting sample prepared in TCB. This flow rate marker was used to linearly correct the flow rate for all samples by alignment of the decane peaks.

### Density

Density was measured in accordance with ASTM D 792. About 16 g of polymer material was pressed (Monarch ASTM Hydraulic Press—Model No. CMG30H-12-ASTM) into a “one inch×one inch” die) at 190° C., at 5600 lbf, for six minutes. Then the pressure was increased to 15 tonf, while simultaneously cooling the sample from 190° C. to 30° C., at 15° C./minute.

### Melt Index

Melt indexes (I2: 190° C./2.16 kg; and I10: 190° C./10.0 kg) were measured according to ASTM test method D1238.

### Octene Incorporation

Octene incorporation was measured using NICOLET MAGNA 560 SPECTROMETER. Thin films of the calibration material, approximately 0.05-0.14 mm in thickness, were prepared by compression molding, at 190° C. and 20,000 psi, for one minute, about 8-10 mg polymer sample between TEFLON coated sheets or aluminum foil. The absorbance of each film was collected using 32 scans in the background. Sample spectra were collected, with a resolution of 4 cm⁻¹ or lower, 1 level of zero filling, and Happ-Genzel apodization function. The obtained spectra (standard) were baseline corrected at 2450 cm¹. The second derivative of the normalized absorbance spectra was calculated over 4000-400 cm⁻¹ interval. To generate the calibration curve, the “peak-to-peak values” of the second derivative spectra for the controlled samples were calculated over the 1390-1363 cm⁻¹ interval, recorded, and plotted against the weight percent octene in each polymer control, as determined by 13C NMR. The octene levels in the polymers prepared herein were calculated using the calibration curve.

### Mooney Viscosity

Mooney Viscosity (ML1+4 at 125° C.) was measured in accordance with ASTM 1646, with a one minute preheat time and a four minute rotor operation time. The instrument is an Alpha Technologies Mooney Viscometer 2000.

The following examples illustrate, but do not, either explicitly or by implication, limit the present invention.

### Experimental

### Representative Dispersion Polymerization (Inventive)

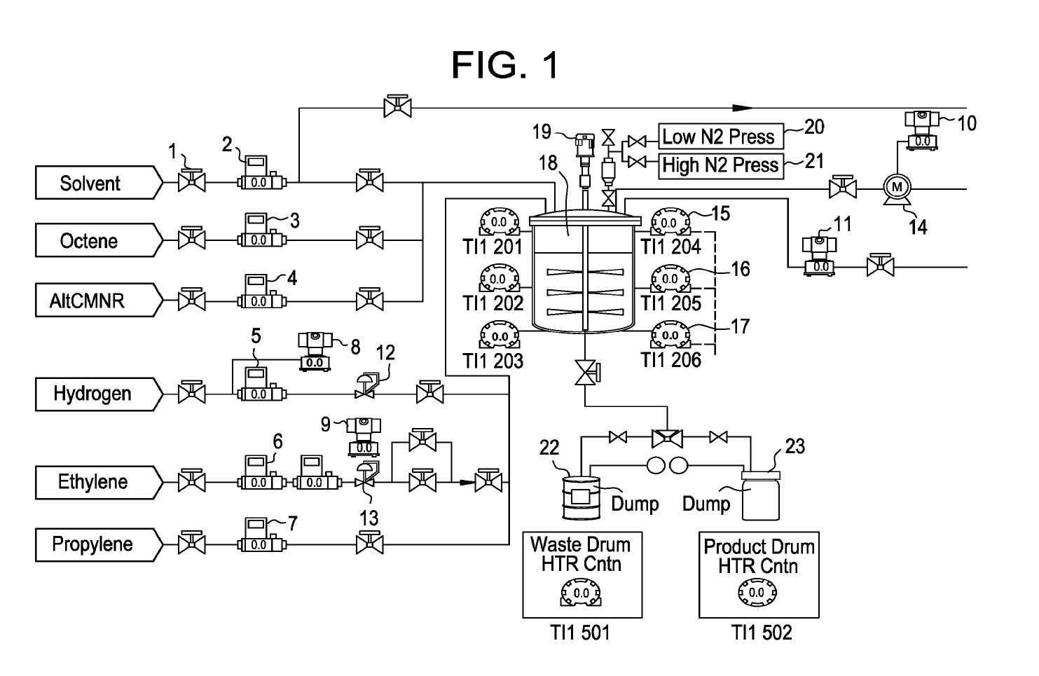

A semi-batch reactor, controlled using a Siemen's controller, was used in the polymerization. A flow schematic of the polymerization is shown in FIG. 1. The stainless steel, non-adiabatic, reactor [18] was equipped with a magnedrive agitator [19] and numerous ports for the feed, analytical probes and a coolant. The feed was monitored using automated block valves [1] and mass flow controllers [2-9]. The catalyst addition was controlled by using a catalyst pump [14], while the pump pressure [10] was monitored. The catalyst can also be added manually, by using either high pressure [20] or low pressure nitrogen [21]. The non-adiabatic reactor was heated using electrical heaters, and the temperature was monitored using Type J thermocouples [15-17]. At the end of the reaction, the product was either accumulated in a kettle [23] or in a dump drum [22]. For accuracy, hydrogen addition was controlled by using a back pressure regulator [12].

First, octene was added to the reactor at a flow rate of 160 g/min Second, isopentane solvent was added slowly to the reactor at 14-70 g/minute, to minimize evaporation of the solvent (bp=27.85° C.). Next, the reactor pressure was raised to 100 psi (6.9 bar) by adding ethylene. This step prevented vaporization of the isopentane, and the associated pressure build-up above the feed pressure of hydrogen. The reactor was then heated to 170° C., and ethylene was added to maintain a specified reactor pressure (450-750 psig).

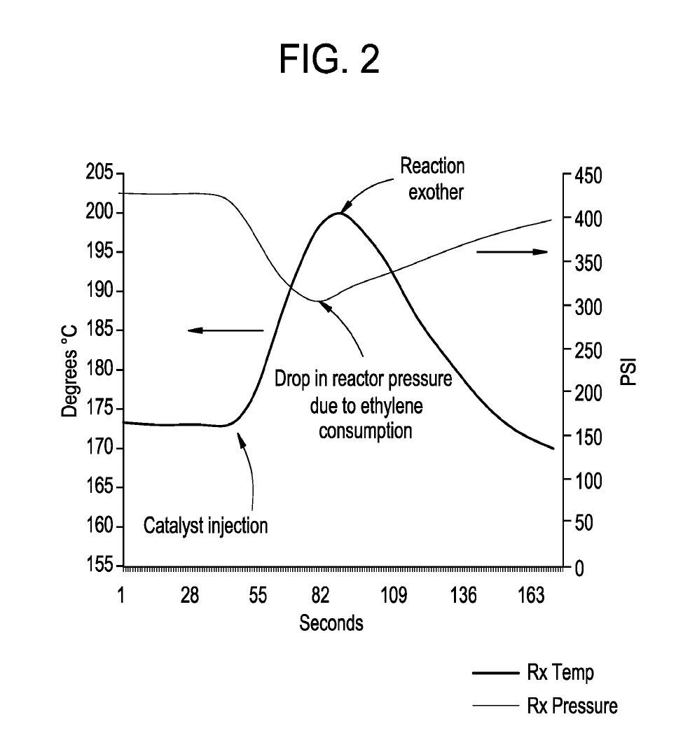

The octene, solvent (isopentane), and hydrogen additions were each controlled using a flow controller. The ethylene addition was controlled using a pressure regulator. The reaction mixture was stirred continuously, at 1400 rpm, to maintain homogenous conditions. To start the polymerization, a solution, containing the catalyst, cocatalyst and a scavenger, was automatically injected at 8 ml/min, using a high pressure reciprocating pump (ACCUFLOW SERIES II), rated up to 1500 psi. The catalyst was zirconium,dimethyl-[(2,2′-[1,3-propanediylbis(oxy-kO)]bis[3″,5,5″-tris(1,1-dimethylethyl)-5′-methyl[1,1′:3′,1″-terphenyl]-2′-olato-kO]](2-)]-,(OC-6-33)-). See International Publication No. WO 2007/136494 (Cat. A11), fully incorporated herein by reference. This catalyst was activated using a tetrapentafluorophenyl-borate cocatalyst. A modified methylalumoxane was used as a scavenger. During the polymerization, ethylene was fed to the reactor to maintain a constant reactor pressure. Due to the exothermic nature of the ethylene polymerization, the reactor temperature increased, as the reactor pressure dropped, due to ethylene consumption (see FIG. 2). The reactor temperature was controlled by circulating a glycol coolant, at 40° C., through the walls of the reactor.

The polymerization was completed in about ten minutes, and the polymer was dumped, at 170° C., into a product kettle located under the reactor. The polymer sample was washed with ISOPAR E at 190° C. The sample was air dried, and subsequently vacuum dried, in a vacuum oven at 80° C., to remove residual solvent. The dried sample was analyzed for density, octene incorporation, and molecular weight characteristics.

### Representative Solution Polymerization (Comparative)

A semi-batch reactor, controlled using a Siemen's controller, was used in the polymerization. A flow schematic of the polymerization is shown in FIG. 1. First, octene was added to the reactor at a flow rate of 160 g/min. Next ISOPAR E solvent was added at a rate of 400 g/minute. The reactor was subsequently heated to 170° C., using electrical band heaters. Next, hydrogen was added at 160 sccm (standard cubic centimeters), followed by ethylene addition, at an amount required to reach the desired reactor pressure (380-750 psig). The octene, solvent (ISOPAR E), and hydrogen additions were each controlled using a flow controller. The ethylene addition was controlled using a pressure regulator. The reaction mixture was stirred continuously at 1400 rpm to maintain homogenous conditions. To start the polymerization, a solution, containing the catalyst, cocatalyst and a scavenger, was automatically injected at 8 ml/min, using a high pressure reciprocating pump (ACCUFLOW SERIES II), rated up to 1500 psi. The catalyst was zirconium, dimethyl[(2,2′-[1,3-propanediylbis(oxy-kO)]bis[3″,5,5″-tris(1,1-dimethylethyl)-5′-methyl[1,1′:3′,1″-terphenyl]-2′-olato-kO)]](2-)]-,(OC-6-33)-). See International Publication No. WO 2007/136494 (Cat. A11), fully incorporated herein by reference. This catalyst was activated using a tetrapentafluorophenyl-borate cocatalyst. A modified methylalumoxane was used as a scavenger.

During the polymerization, ethylene was fed to the reactor to maintain a constant reactor pressure. Due to the exothermic nature of the ethylene polymerization, the reactor temperature increased as the reactor pressure dropped, due to ethylene consumption. The reactor temperature was controlled by circulating a glycol coolant, at 40° C., through the walls of the reactor.

The polymerization was completed in about ten minutes, and the polymer was dumped, at 170° C., into a product kettle located under the reactor. The polymer sample was washed with ISOPAR E at 190° C. The sample was air dried, and subsequently vacuum dried, in a vacuum oven at 80° C., to remove residual solvent. The dried sample was analyzed for density, octene incorporation, and molecular weight characteristics.

Polymerization conditions for the inventive and comparative examples are shown in Tables 1a and 1b and Tables 2a and 2b, respectively. Polymer properties are shown in Tables 3 and 4. The properties of two commercial polymers, prepared by a solution polymerization, are shown in Table 5.

TABLE 1a
Dispersion Polymerizations (Inventive)

| Run | | Temperature | Pressure | Catalyst | Cocatalyst |
|---|---|---|---|---|---|
| # | Solvent | (° C.) | (psig) | (micromol) | (micromol) |
| 1 | Isopentane | 168.5 | 610.8 | 1.25 | 1.5 |
| 2 | | 169.1 | 614.5 | 1.25 | 1.5 |
| 3 | | 170.5 | 623.5 | 2 | 2.4 |
| 4 | | 170.3 | 619.1 | 2 | 2.4 |
| 5 | | 170.3 | 613.9 | 1.25 | 1.5 |
| 6 | | 169.3 | 613.1 | 1.25 | 1.5 |
| 7 | | 170 | 610.2 | 1.25 | 1.5 |
| 8 | | 169.7 | 613.6 | 1.25 | 1.5 |
| 9 | | 169.8 | 610.8 | 1.25 | 1.5 |
| 10 | | 169.7 | 610.8 | 1.25 | 1.5 |
| 11 | | 171.1 | 620.9 | 1.25 | 1.5 |
| 12 | | 169.5 | 613.6 | 1.25 | 1.5 |

TABLE 1b
Dispersion Polymerizations (Inventive)

| | | Mol | Mol | | |
|---|---|---|---|---|---|
| Run | Efficiency | fraction | fraction | Mole | Hydrogen |
| # | (C2 consumed/gm Zr) | ethylene | Octene | C2/C8 | (sccm) |
| 1 | 2.8E+05 | 0.210 | 0.149 | 1.41 | 10 |
| 2 | 5.9E+05 | 0.209 | 0.149 | 1.40 | 10 |
| 3 | 5.8E+05 | 0.185 | 0.163 | 1.13 | 20 |
| 4 | 5.5E+05 | 0.212 | 0.148 | 1.43 | 20 |
| 5 | 3.9E+05 | 0.180 | 0.164 | 1.09 | 30 |
| 6 | 7.1E+05 | 0.181 | 0.165 | 1.10 | 30 |
| 7 | 6.0E+05 | 0.177 | 0.165 | 1.08 | 50 |
| 8 | 5.3E+05 | 0.180 | 0.162 | 1.11 | 50 |
| 9 | 3.0E+05 | 0.177 | 0.162 | 1.10 | 75 |
| 10 | 4.0E+05 | 0.178 | 0.162 | 1.10 | 75 |
| 11 | 5.1E+05 | 0.180 | 0.162 | 1.11 | 120 |
| 12 | 6.0E+05 | 0.181 | 0.163 | 1.11 | 120 |

TABLE 2a
Solution Polymerizations (Comparative)

| Run | | Temperature | Pressure | Catalyst | Cocatalyst |
|---|---|---|---|---|---|
| # | Solvent | (° C.) | (psig) | (micromol) | (micromol) |
| A | ISOPAR-E | 168.7 | 398.4 | 2 | 2.4 |
| B | | 170.2 | 399.8 | 2 | 2.4 |
| C | | 169 | 397.5 | 2 | 2.4 |
| D | | 168.7 | 400.7 | 2 | 2.4 |
| E | | 168.6 | 400.7 | 2 | 2.4 |
| F | | 168.7 | 399 | 2 | 2.4 |
| G | | 168.7 | 398.4 | 2 | 2.4 |
| H | | 168.8 | 399 | 2 | 2.4 |
| I | | 169 | 399.5 | 2 | 2.4 |
| J | | 168.9 | 397.8 | 2 | 2.4 |
| K | | 169.4 | 398.1 | 2 | 2.4 |

TABLE 2b
Solution Polymerizations (Comparative)

| | | Mol | Mol | | |
|---|---|---|---|---|---|
| Run | Efficiency | fraction | fraction | Mole | Hydrogen |
| # | (C2 consumed/gm Zr) | ethylene | octene | C2/C8 | (sccm) |
| A | 6.1E+05 | 0.181 | 0.140 | 1.30 | 10 |
| B | 4.6E+05 | 0.185 | 0.139 | 1.34 | 10 |
| C | 7.0E+05 | 0.184 | 0.139 | 1.33 | 20 |
| D | 6.9E+05 | 0.178 | 0.139 | 1.28 | 20 |
| E | 8.2E+05 | 0.186 | 0.138 | 1.35 | 20 |
| F | 6.3E+05 | 0.184 | 0.139 | 1.32 | 30 |
| G | 6.6E+05 | 0.185 | 0.138 | 1.33 | 30 |
| H | 4.8E+05 | 0.182 | 0.139 | 1.31 | 50 |
| I | 4.1E+05 | 0.187 | 0.137 | 1.36 | 50 |
| J | 5.8E+05 | 0.178 | 0.139 | 1.28 | 75 |
| K | 5.5E+05 | 0.174 | 0.141 | 1.24 | 75 |

TABLE 3
Inventive Polymers

| | | wt % | | | | | |
|---|---|---|---|---|---|---|---|
| | Yield | Octene | Density | Mw (abs) | MWD | I₂ | |
| Run # | (gm) | incorp. | (g/cc) | g/mole | Mw(abs)/Mn(abs) | (g/10 min) | I₁₀/I₂ |
| 1 | 13.4 | 31.07 | 0.8727 | 342730 | 2.69 | Low | |
| 2 | 43.6 | 30.37 | 0.8751 | 376080 | 2.97 | | |
| 3 | 125.7 | 33.47 | 0.8625 | 255980 | 2.44 | | |
| 4 | 154.6 | 34.14 | 0.8564 | 251930 | 2.80 | | |
| 5 | 61.5 | 32.58 | 0.871 | 213700 | 2.62 | | |
| 6 | 111.9 | 33.5 | 0.8706 | 216200 | 2.50 | 0.02 | 18.46 |
| 7 | 34.4 | 35.93 | 0.8704 | 217480 | 2.88 | | |
| 8 | 32.7 | 37.68 | 0.868 | 128700 | 2.62 | 1.35 | 11.44 |
| 9 | 46.3 | 35.32 | 0.8714 | 106170 | 2.75 | 3.26 | 8.69 |
| 10 | 17.6 | 38.43 | 0.8683 | 75660 | 2.55 | | |
| 11 | 42.5 | 32.78 | 0.8712 | 89110 | 4.39 | 6.92 | 10.62 |
| 12 | 57.2 | 38.46 | 0.8699 | 87680 | 3.26 | 7.92 | 10.93 |

TABLE 4
Comparative Polymers

| | | wt % | | | | | |
|---|---|---|---|---|---|---|---|
| | Yield | Octene | Density | Mw(abs) | MWD | I₂ | |
| Run # | (gm) | incorp. | (g/cc) | (g/mole) | Mw(abs)/Mn(abs) | (g/10 min) | I₁₀/I₂ |
| A | 170 | 27.66 | 0.8684 | 152,480 | 2.06 | 0.27 | 9.78 |
| B | 109 | 26.31 | 0.8737 | 165,230 | 2.19 | 0.071 | 11.35 |
| C | 172 | 27.76 | 0.8787 | 117,350 | 2.10 | 0.58 | 9.04 |
| D | 189 | 27.69 | 0.8743 | 121,840 | 2.18 | 0.71 | 8.32 |
| E | 230 | 27.74 | 0.8697 | 116,950 | 2.14 | 0.88 | 8.99 |
| F | 160 | 28.53 | 0.8758 | 91,020 | 2.15 | 2.8 | 7.48 |
| G | 155 | 28.11 | 0.8793 | 93,570 | 2.05 | 2.31 | 7.42 |
| H | 108 | 28.09 | 0.8787 | 62,900 | 2.22 | 9.5 | 7.01 |
| I | 102 | 27.13 | 0.8814 | 71,390 | 1.96 | 7.85 | 6.76 |
| J | 142 | 29.98 | 0.8779 | 51,180 | 1.85 | 38.06 | 7.22 |
| K | 141 | 32.41 | 0.8766 | 49,210 | 2.16 | 41.67 | 6.97 |

TABLE 5
Commercial Polymers

| | Octene | | | | | |
|---|---|---|---|---|---|---|
| | Incorp. | Density | Mw | | I₂ | |
| Comm. # | (wt %) | (g/cc) | (g/mole) | Mw/Mn | (g/10 min) | I₁₀/I₂ |
| L* | 28.4 | 0.885 | 98,807 | 2.3 | 1 | 7.9 |
| M** | 18.1 | 0.902 | 112,322 | 2.9 | 1 | 9.0 |

*L = ENGAGE 8003 Polyolefin Elastomer
**M = AFFINITY PL1880 Polyolefin Plastomer

Feed partitioning, before and after reaction completion, for Run #12 is shown in Table 6.

TABLE 6

| | | | |
|---|---|---|---|
| | Octene mol | Ethylene mol | Molar |
| Phase | fraction | fraction | Ethylene: Octene |

Before reaction

| | | | |
|---|---|---|---|
| Solvent | 0.16 | 0.179 | 1.09 |

At the end of the Reaction

| | | | |
|---|---|---|---|
| Solvent | 0.14 | 0.17 | 1.22 |
| Polymer | 0.18 | 0.14 | 0.76 |

As discussed above, Tables 1 and 2 describe the experimental conditions, including reactor pressure, temperature, and hydrogen concentration, for inventive dispersion polymerizations and comparative solution polymerizations. Tables 3 and 4 depict the polymer properties for the different reactor conditions. Increasing the hydrogen concentration, at a given monomer-comonomer concentration, lowered the molecular weight for repeated runs. However, it was discovered that at a given hydrogen concentration, polymerization in isopentane resulted in polymer with higher molecular weight than that made in ISOPAR-E (compare Run 1 (Table 3) and Run A (Table 4)). Further, it has been discovered that after a “two liquid phase” formation in isopentane, solubility of hydrogen in polymer phase was still lower by a factor of six, as compared to that for the isopentane solvent, which resulted in polymer with higher molecular weight, irrespective of the phase in which it was formed. This influence of hydrogen was also reflected in the melt index and I₁₀/I₂ ratio. The samples made at lower hydrogen concentration exhibited low melt index, and this value increased upon increasing the hydrogen concentration, due to corresponding lowering of the molecular weight.

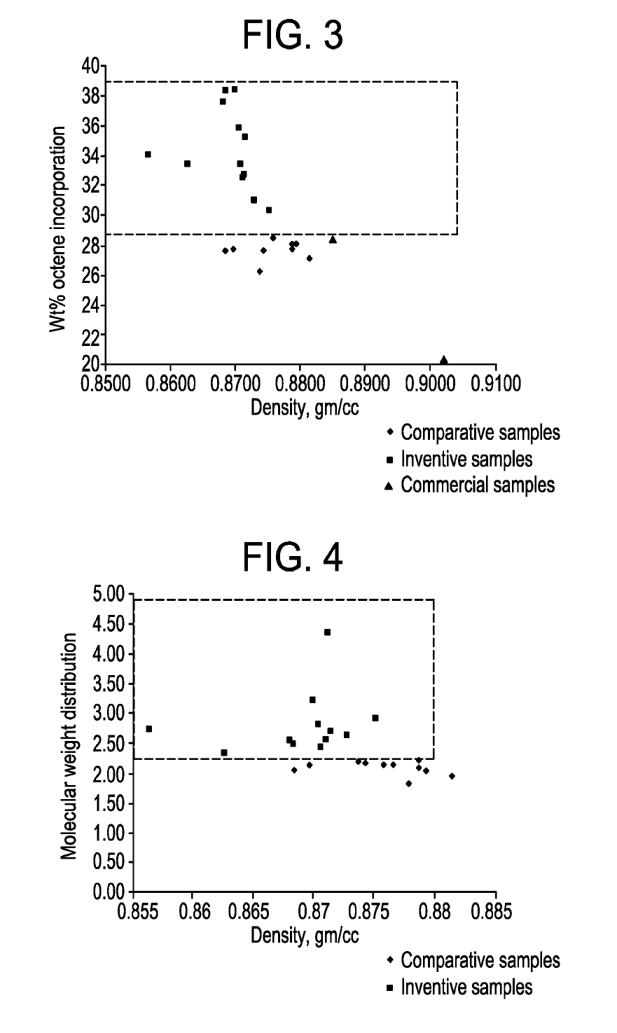

It has also been discovered, as shown in FIG. 3, that the inventive polymers have higher octene incorporation, leading to lower polymer density. This higher octene incorporation may be explained by a change in the ethylene:octene ratio after two phase formation (solvent phase it increased and decreased in polymer phase). Specifically, as shown in Table 6, it has been discovered that the ethylene:octene ratio changed from an initial value of 1.09, for the solution, to 0.76, in the polymer phase, due to higher octene solubility in the polymer phase. The increased octene solubility in the polymer phase leads to higher octene incorporation, and hence lower polymer density. It has also been discovered, as shown in FIG. 4, the inventive polymers have a broader molecular weight distributions (Mw(abs)/Mn(abs)), as compared to the comparative polymers at similar polymer densities. Thus, the inventive polymers have higher molecular weights (Mw(abs)), using about the same hydrogen concentration as in the solution polymerizations. The inventive polymers also have higher octene incorporation, and more, or comparable, amounts of long chain branching. Thus, the inventive polymers should have improved processibility (MWD and Mw) and improved toughness (amount of octene incorporation), compared to the comparative polymers.

Although the invention has been described in considerable detail in the preceding examples, this detail is for the purpose of illustration, and is not to be construed as a limitation on the invention, as described in the following claims.

### EPDM Polymerizations

The dispersion polymerization discussed above can also be applied to the polymerization of EPDM polymers. An EPDM was polymerized by dispersion polymerization in isopentane. The resulting EPDM has a Mooney Viscosity (ML 1+4, 125° C.) of 23, a Mw of 137,050 g/mole, and a Mw/Mn of 3.01.

1. A composition comprising an ethylene-based polymer comprising at least the following properties:
a) a weight average molecular weight (Mw(abs)) greater than, or equal to, 60,000 g/mole; and
b) a molecular weight distribution (Mw(abs)/Mn(abs)) greater than, or equal to, 2.3.

2. The composition of claim 1, wherein the ethylene-based polymer further comprises a density from 0.85 to 0.91 g/cc.

3. The composition of claim 1, wherein the ethylene-based polymer is an ethylene/α-olefin interpolymer.

4. The composition of claim 1, wherein the ethylene-based polymer is an ethylene/α-olefin copolymer.

5. The composition of claim 1, wherein the ethylene-based polymer has an α-olefin incorporation greater than, or equal to, 30 weight percent, based on the weight of the polymer.

6. The composition of claim 1, wherein the ethylene-based polymer has a molecular weight distribution (MWD) from 2.3 to 5.0.

7. The composition of claim 1, wherein the ethylene-based polymer has a density greater than 0.855 g/cc, and an α-olefin incorporation greater than, or equal to, 30 weight percent, based on the weight of the polymer.

8. The composition of claim 1, wherein the ethylene-based polymer has a density greater than 0.855 g/cc, and a molecular weight distribution (MWD) greater than, or equal to, 2.4.

9. The composition of claim 1, wherein the ethylene-based polymer has an alpha parameter less than 0.72.

10. The composition of claim 1, wherein the ethylene-based polymer has a weight average molecular weight (Mw(abs)) greater than, or equal to, 80,000 g/mole.

11. The composition of claim 1, wherein the ethylene-based polymer has a I10/I2 ratio greater than, or equal to, 8.0.

12. The composition of claim 1, wherein the ethylene-based polymer has a I10/I2 ratio greater than, or equal to, 10.0.

13. The composition of claim 1, further comprising at least one additive.

14. An article comprising at least one component formed from the composition of claim 1.

15. The article of claim 14, wherein the article is selected from a gasket, or a profile.
